(19) United States
(12) Patent Application Publication
(10) Pub. No.: US 2009/0313416 A1
(43) Pub. Date: Dec. 17, 2009

(54) Computer main memory incorporating volatile and non-volatile memory

(76) Inventor: George Wayne Nation, Rochester, MN (US)

Correspondence Address: LSI Corporation c/o Suiter Swantz pc llo, 14301 FNB Parkway, Suite 220, Omaha, NE, 68154, US

(21) Appl. No.: 12/214,030

(22) Filed: Jun. 16, 2008

(51) Int. Cl. G06F 12/00

(52) U.S. Cl. 711/100; 711/E12.001

(57) ABSTRACT

A main memory for a computer system comprises a controller including an interface to one or more processors, non-volatile memory, and volatile memory. The main memory comprises one or more contiguous range of real addresses supported by both the non-volatile memory and the volatile memory. The controller may be incorporated into a mainboard and the non-volatile memory and the volatile memory may comprise pluggable memory modules. Alternatively, the controller may be incorporated into a hybrid pluggable memory module including non-volatile memory and volatile memory. The controller may utilize the volatile memory as a cache for the non-volatile memory. One or more subsets of the non-volatile memory may be configured to contain a system image, an operating system managed emulated disk image, and/or an operating system managed a page-file. The controller may encrypt and/or compress data written to and/or decrypt and/or decompress data read from the non-volatile memory.

### TECHNICAL FIELD

The present disclosure generally relates to the field of computer systems, and more particularly to a main memory for a computer system.

### BACKGROUND

Main memory is physical memory that is internal to a computing device. Main memory differs from processor caches and processor registers in that main memory is external to one or more processors of the computing device. Main memory is typically the only storage directly accessible to one or more processors of a computing device, typically via a memory bus (also referred to as a front side bus) directly or indirectly coupling the main memory to the one or more processors of the computing device. A memory bus typically comprises an address bus and a data bus. The one or more processors of a computing device typically sends a real memory address (or physical memory address), indicated the desired location of data, through the address bus and then reads and/or writes data utilizing the data bus. The one or more processors of a computing device write data to main memory, read data from main memory, execute instructions stored in main memory, and/or operate on data stored in main memory. Random access memory (RAM) is frequently utilized as main memory in computing devices.

Flash memory is a non-volatile computer memory (computer memory that can retain stored information even when not powered) that can be electrically erased and reprogrammed. Flash memory, including NAND flash memory, is erased and programmed in blocks. Flash memory typically is limited by block erasure (although the flash memory can be read or programmed a byte or word at a time in random access fashion, it must be erased a block at a time) and memory wear (the flash memory typically has a finite number of erase-write cycles). Memory wear is typically offset by wear leveling, or counting writes and dynamically remapping blocks to spread write operations between sectors. Flash memory offers fast read access times, though not typically as fast as DRAM (dynamic random access memory). DRAM is a type of random access memory that stores each bit of data in a separate capacitor within an integrated circuit. DRAM is dynamic, as opposed to static memory such as SRAM (static random access memory), because information stored in DRAM eventually fades unless refreshed periodically. DRAM is volatile (memory that requires power to maintain stored information).

### SUMMARY

A main memory for a computer system may comprise a controller including an interface communicatively coupled to one or more processors, non-volatile memory communicatively coupled to the controller, and volatile memory communicatively coupled to the controller. The main memory may comprise one or more contiguous range of real addresses supported by both the non-volatile memory and the volatile memory. The non-volatile memory may be capable of containing data for every address in the one or more contiguous range of real addresses. The volatile memory may be smaller than the non-volatile memory and may be capable of holding data for at least a subset of the one or more contiguous range of real addresses. The non-volatile memory may comprise flash memory such as NOR flash memory and/or NAND flash memory. The volatile memory may comprise DRAM (dynamic random access memory).

The controller may be incorporated into the mainboard of the computer system and the non-volatile memory and the volatile memory may comprise pluggable memory modules such as DIMMs (dual in-line memory modules). Alternatively, the controller may be incorporated into a hybrid pluggable memory module, such as a DIMM, which includes at least a portion of the non-volatile memory and at least a portion of the volatile memory.

The controller may utilize the volatile memory as a cache for the non-volatile memory. The controller may be configured to transfer data directly or indirectly between the non-volatile memory and the volatile memory to perform cache functions including, but not limited to, cache fills and/or page-in emulation operations. The cache may be configured to retain data contained in at least one pinned address.

One or more subsets of the non-volatile memory may be configured to contain a system image from a computer system utilized to maintain the state of the computer system when the computer system is deprived of power and/or when the computer system enters a power saving mode. One or more subsets of the non-volatile memory may be configured to contain an emulated disk image managed by an operating system of a computer system. One or more subsets of the non-volatile memory may be configured as a data region for containing a page-file for an operating system of the computer system.

The controller may encrypt data written to the non-volatile memory and/or decrypt data read from the non-volatile memory to ensure that any persistent data contained in the non-volatile memory is encrypted. The controller may compress data written to the non-volatile memory and/or decompress data read from the non-volatile memory to reduce the amount of physical memory required to hold a line, page or other useful granule of memory.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram illustrating a typical computer system;

FIG. 2 is a block diagram illustrating a main memory that may be utilized in the computer system illustrated in FIG. 1, in accordance with an embodiment of the present disclosure;

FIG. 3 is a block diagram of an example configuration of the main memory controller of the main memory illustrated in FIG. 2, in accordance with an embodiment of the present disclosure;

FIG. 4 is a block diagram illustrating a main memory that may be utilized in the computer system illustrated in FIG. 1, in accordance with an alternative embodiment of the present disclosure;

FIG. 5 is a diagram illustrating an example configuration of a hybrid memory module of the main memory of FIG. 4, in accordance with an embodiment of the present disclosure; and

FIG. 6 is a block diagram of an example configuration of the module controller of the hybrid memory module illustrated in FIG. 5, in accordance with an embodiment of the present disclosure.

### DETAILED DESCRIPTION

Reference will now be made in detail to the subject matter disclosed, which is illustrated in the accompanying drawings.

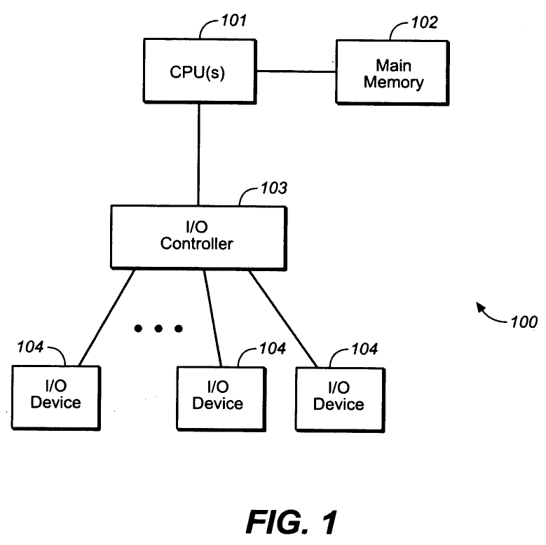

FIG. 1 illustrates a block diagram of a typical computer system 100. The computer system 100 may comprise any kind of computing device including, but not limited to, digital computer devices such as personal desktop computers, personal laptop computers, server computers, mainframe computers, minicomputers, routers, attached storage devices, and/or. The computer system 100 may include one or more processors (or central processing units) 101, a main memory 102 communicatively connected to the one or more processors 101, an I/O (input/output) controller communicatively connected to the one or more processors 101, and one or more I/O devices 104 communicatively connected to the I/O controller 103.

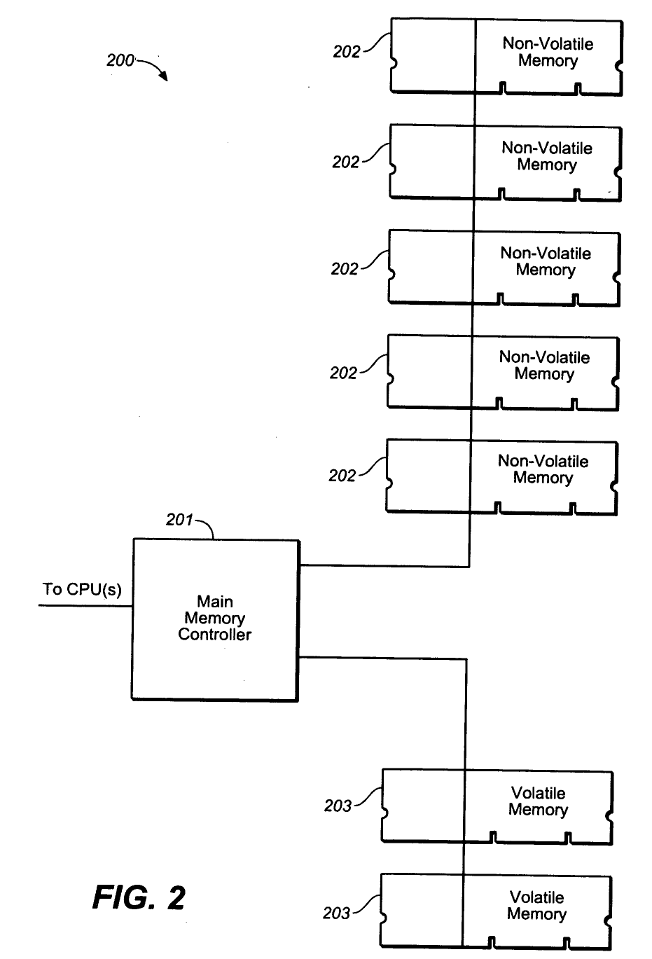

FIG. 2 illustrates an embodiment of a main memory 200 that may be utilized as the main memory 102 of the computer system 100. In this embodiment, main memory 200 comprises a main memory controller 201 which includes an interface (including, but not limited to, HyperTransport or other front-side bus technology) communicatively coupled to one or more processors (or CPUs), non-volatile memory 202 communicatively coupled to the main memory controller 201, and volatile memory 203 communicatively coupled to the main memory controller 201. The main memory 200 may comprise one or more contiguous range of real addresses (e.g. physical memory addresses). The one or more contiguous range of real addresses may be supported by both the non-volatile memory 202 and the volatile memory 203. The non-volatile memory 202 may be capable of containing data for every address in the one or more contiguous range of real addresses. The volatile memory 203 may be smaller (e.g. containing less data) than the non-volatile memory 202 and may be capable of holding data for at least a subset of the one or more contiguous range of real addresses. The non-volatile memory 202 may comprise flash memory such as NOR flash memory and/or NAND flash memory. The volatile memory 203 may comprise DRAM (dynamic random access memory).

As illustrated, main memory controller 201 is incorporated into the mainboard of a computer system. However, it should be understood that main memory controller 201 may be separate from a mainboard of a computer system without departing from the scope of the present disclosure. As illustrated, the non-volatile memory 202 and the volatile memory 203 are each communicably coupled to the main memory controller 201 by a single interface and/or lane. However, it should be understood that the main memory controller 201 may include any number of interfaces and/or lanes for communicably coupling to the non-volatile memory 202 and/or the volatile memory 203 and each interface and/or lane may be communicably coupled to one or more modules of the non-volatile memory 202 and/or the volatile memory 203 without departing from the scope of the present disclosure. As illustrated, the non-volatile memory 202 and the volatile memory 203 comprise DIMMs (dual in-line memory modules). The non-volatile memory 202 DIMMs illustrated include a printed circuit board, a pluggable connector coupled to the printed circuit board, and a portion of the non-volatile memory 202 communicatively coupled to the pluggable connector. The volatile memory 203 DIMMs illustrated include a printed circuit board, a pluggable connector coupled to the printed circuit board, and a portion of the volatile memory 203 communicatively coupled to the pluggable connector. However, the non-volatile memory 202 and the volatile memory 203 may comprise other kinds of pluggable modules without departing from the scope of the present disclosure including, but not limited to, SIMMs (single in-line memory modules), SO-DIMMs (small outline DIMMs), MicroDimms, Mini-DIMMs, VLP (very low profile) Mini-DIMMs, DIPs (dual in-line packages), SIPs (single in-line packages), and/or ZIPs (zig-zag in-line packages). As illustrated, non-volatile memory 202 comprises five pluggable modules. However, it should be understood that non-volatile memory 202 may comprise other numbers of pluggable modules without departing from the scope of the present disclosure, such as one or fifty. As illustrated, volatile memory 203 comprises two pluggable modules. However, it should be understood that volatile memory 203 may comprise other numbers of pluggable modules without departing from the scope of the present disclosure, such as one or twenty.

The main memory controller 201 may utilize the volatile memory 203 as a cache for the non-volatile memory 202. A cache is a collection of data duplicating original values stored elsewhere or computed earlier, where the original data is expensive to fetch (owing to longer access time) or to compute, compared to the cost of reading the cache. Upon receipt of a read and/or write command from one or more processing units, the main memory controller 201 may utilize the volatile memory 203 if data related to one or more real addresses is contained within the volatile memory 203 and may only utilize the non-volatile memory 202 if data related to the one or more real addresses is not contained within the volatile memory 203. The main memory controller 201 may be configured to transfer data directly or indirectly between the non-volatile memory 202 and the volatile memory 203 to perform cache functions including, but not limited to, cache fills and/or page-in emulation operations. The cache may be configured to retain data contained in at least one pinned address. For example, data in the cache relating to frequently accessed real addresses may be “pinned” so that the data is retained in the cache rather than being overwritten with data relating to other real addresses during caching operations.

One or more subsets of the non-volatile memory 202 may be configured to contain a system image from a computer system. The system image may comprise the state of the computer system. The system image may be utilized to maintain the state of the computer system when the computer system is deprived of power (including, but not limited to, powering off of the computer system, power failures, and/or other power deprivations) and/or when the computer system enters a power saving mode (such as a hibernation feature where the state of a computer system is saved and power is not supplied to one or more components). The system image may be managed by the computer system. The system image may be managed by an operating system of the computer system.

One or more subsets of the non-volatile memory 202 may be configured to contain an emulated disk image. An emulated disk image is a collection of data utilized to emulate the contents and structure of a data storage medium or device, such as a hard drive, CD (compact disk), or DVD (digital video disk). The emulated disk image may be utilized as if it were the emulated data storage medium or device. The emulated disk image may be managed by an operating system of a computer system.

One or more subsets of the non-volatile memory 202 may be configured as a data region for containing a page-file. The page-file may comprise a portion of memory, managed by an operating system of a computer system, where the operating system is able to load data from an auxiliary storage, such as a hard disk drive. As the page-file is typically not capable of containing the entirety of the auxiliary storage, the data may be divided in one or more pages and swapped in and/or out of the page-file by the operating system when required.

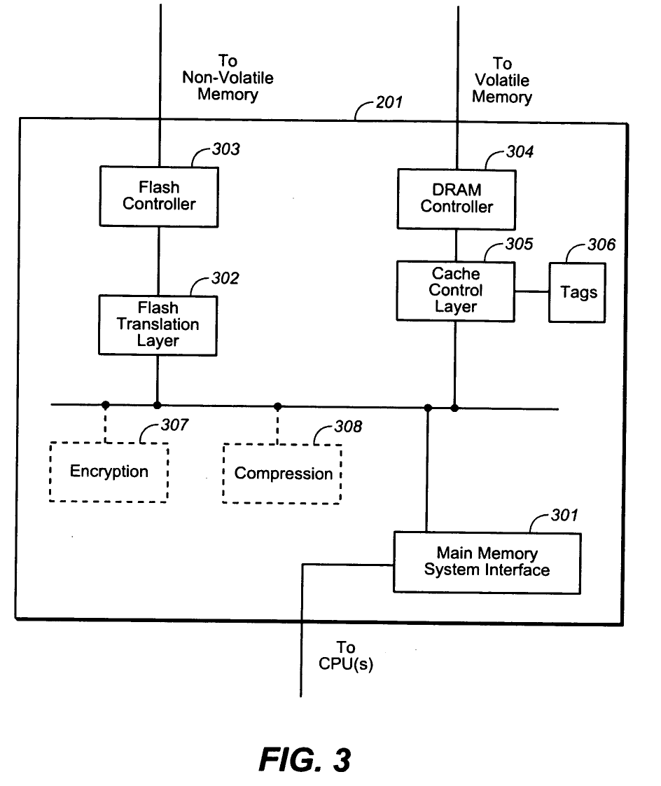

FIG. 3 illustrates an example configuration of main memory controller 201. The main memory controller 201 may include a main memory system interface 301, a flash translation layer 302 communicatively coupled to the main memory system interface 301, a cache control layer 305 communicatively coupled to the flash translation layer 302 and the main memory system interface 301, a cache tag memory 306 communicatively coupled to the cache control layer 305, a non-volatile memory controller 303 (which may comprise a flash controller) communicatively coupled to the flash translation layer 302 and the non-volatile memory 202, a volatile memory controller 304 (which may comprise a DRAM controller) communicatively coupled to the cache control layer 305 and the volatile memory 203. Although the nonvolatile memory controller 303 is illustrated as having a single interface and/or lane to the non-volatile memory, it should be understood that the nonvolatile memory controller 303 may include any number of interfaces and/or lanes to the nonvolatile memory 202, each interface and/or lane connecting to one or more modules of the nonvolatile memory 202. Although the volatile memory controller 304 is illustrated as having a single interface and/or lane to the non-volatile memory, it should be understood that the nonvolatile memory controller 304 may include any number of interfaces and/or lanes to the volatile memory 203, each interface and/or lane connecting to one or more modules of the volatile memory 203. The main memory system interface 301 may receive one or more read and/or write commands with data from one or more processors and may determine whether to pass the one or more read and/or write commands to the flash translation layer 302 and/or the cache control layer 305 for internal processing. The main memory system interface 301 may be configured to transfer data directly or indirectly between the non-volatile memory 202 and the volatile memory 203 utilizing the flash translation layer 302, the non-volatile memory controller 303, the cache control layer 305, the cache tag memory 306, and the volatile memory controller 304.

If the main memory controller 201 utilizes the volatile memory 203 as a cache for the non-volatile memory 202, the main memory system interface 301 may pass the one or more read and/or write commands to the cache controller layer 305 for lookup in the cache tag memory 306. If a read command address is determined to be within a region that is within the volatile memory, the read command may be passed to the volatile memory controller 304 for processing. If the cache control layer 305 determines that a read command address will not be processed by the volatile memory 203 (including, but not limited to, a cache miss) the read command may be passed to the flash translation layer 302. If a write command address is determined to be within a region that is within the volatile memory, the write command and write data may be passed to the volatile memory controller 304 for processing. If the cache control layer 305 determines that a write command address will not be processed by the volatile memory 203 (including, but not limited to, a cache miss) the write command and write data may be passed to the flash translation layer 302.

The flash translation layer 302 may comprise a function that maps real addresses into flash blocks. This remapping and translation function may also manage wear-leveling, block erasure, and other management functions specific to flash memory devices. However, all non-volatile memory preferably utilizes the same set of management and translation functions. If non-volatile memory 202 comprises a type of non-volatile memory other than flash memory, flash translation layer 302 may comprise a different kind of translation layer particular to the kind of non-volatile memory utilized without departing from the scope of the present disclosure. The non-volatile memory controller 303 and/or the volatile memory controller 304 may be responsible for interfacing directly to their respective memory devices and may perform functions including, but not limited to, decoding addresses to the appropriate memory devices, selecting a correct memory device, and/pr issuing the proper protocol to a memory device to read and/or write data.

The main memory controller 201 may also include an encryption unit 307 communicatively coupled to the main memory system interface 301, the flash translation layer 302, and the cache control layer 305. The encryption unit 307 may be configured to encrypt data written to the non-volatile memory 202 and/or decrypt data read from the non-volatile memory 202. The encryption unit 307 may ensure that any persistent data contained in the non-volatile memory 202 is encrypted. The encryption unit 307 may utilize any encryption algorithm including, but not limited to, the Blowfish encryption algorithm, the RSA encryption algorithm, the data encryption standard (DES), the international data encryption algorithm (IDEA), the software-optimized encryption algorithm (SEAL), and/or the RC4 encryption algorithm.

The main memory controller 201 may also include a compression unit 308 (which may utilize a compression architecture similar to that disclosed in U.S. Pat. No. 5,812,817 to Hovis et al., which is herein incorporated in its entirety) communicatively coupled to the main memory system interface 301, the flash translation layer 302, and the cache control layer 305. The compression unit 308 may be configured to compress data written to the non-volatile memory 202 and/or decompress data read from the non-volatile memory 202. The compression unit 308 may be configured to compress data written to the non-volatile memory 202 to reduce the amount of physical memory required to hold a line, page or other useful granule of memory. The compression unit 308 may utilize any compression encoding scheme including, but not limited to, the run-length encoding scheme, the Huffman encoding scheme, the arithmetic encoding scheme, the LZW encoding scheme, and the LZ-77 encoding scheme.

The main memory controller 201 may also include an encryption unit 307 communicatively coupled to the main memory system interface 301, the flash translation layer 302, and the cache control layer 305 and a compression unit 308 communicatively coupled to the main memory system interface 301, the flash translation layer 302, the encryption unit 307, and the cache control layer 305. The encryption unit 307 and the compression unit 308 may be configured to encrypt and compress data written to the non-volatile memory 202, compress and encrypt data written to the non-volatile memory 202, decompress and decrypt data read from the non-volatile memory 202, and/or decrypt and decompress data read from the non-volatile memory 202.

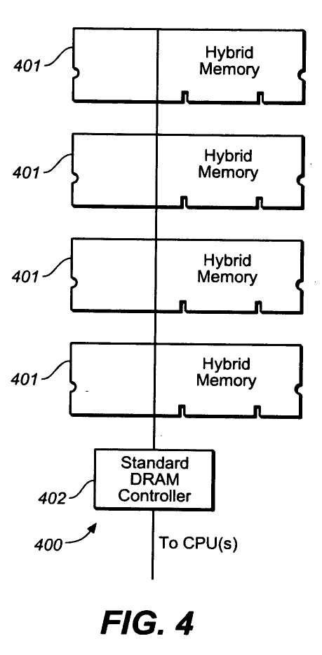

FIG. 4 illustrates an alternative embodiment of a main memory 400 that may be utilized as the main memory 102 of the computer system 100. In this embodiment, main memory 400 comprises hybrid memory modules 401 and an interface (including, but not limited to a standard DIMM interface) communicatively coupled to one or more processors (or CPUs) preferably via a traditional memory controller 402 (which may comprise a standard DRAM controller). As illustrated, the hybrid memory modules 401 are communicably coupled to the traditional memory controller 402 by a single interface and/or lane. However, it should be understood that the traditional memory controller 402 may include any number of interfaces and/or lanes each for communicably coupling to one or more hybrid memory modules 401 without departing from the scope of the present disclosure. The hybrid memory modules 401 may include non-volatile memory and volatile memory. The main memory 400 may comprise one or more contiguous range of real addresses (e.g. physical memory addresses). The one or more contiguous range of real addresses may be supported by both the non-volatile memory and the volatile memory of the hybrid memory modules 401. The non-volatile memory may be capable of containing data for every address in the one or more contiguous range of real addresses. The volatile memory may be smaller (e.g. containing less data) than the non-volatile memory and may be capable of holding data for at least a subset of the one or more contiguous range of real addresses. The non-volatile memory may comprise flash memory such as NOR flash memory and/or NAND flash memory. The volatile memory may comprise DRAM (dynamic random access memory). As illustrated, the hybrid memory modules 401 comprise four pluggable modules. However, it should be understood that hybrid memory modules 401 may comprise other numbers of pluggable modules without departing from the scope of the present disclosure, such as one or seventeen.

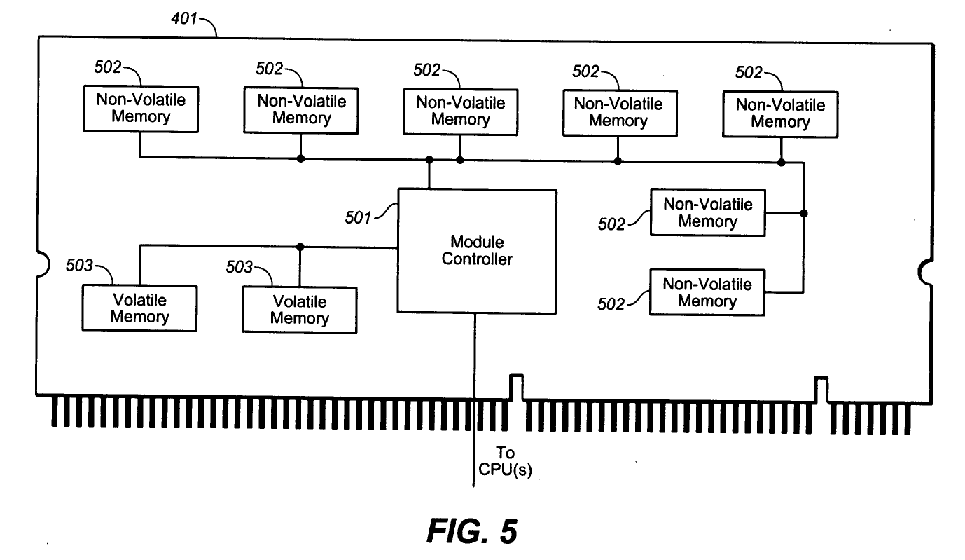

FIG. 5 illustrates an example configuration of a hybrid memory module 401. The hybrid memory module may include a printed circuit board, a pluggable connector coupled to the printed circuit board, a module controller 501 communicatively coupled to the pluggable connector, non-volatile memory 502 communicatively coupled to the module controller 501, and volatile memory 503 communicatively coupled to the module controller 501. As illustrated, the hybrid memory module 401 comprises a DIMM (dual in-line memory module). However, the hybrid memory module 401 may comprise other kinds of pluggable modules without departing from the scope of the present disclosure including, but not limited to, a SIMM (single in-line memory module), a SO-DIMM (small outline DIMM), a MicroDimm, a Mini-DIMM, VLP (very low profile) Mini-DIMM, a DIP (dual in-line package), a SIP (single in-line package), and/or a ZIP (zig-zag in-line package).

The module controller 501 may utilize the volatile memory 503 as a cache for the non-volatile memory 502. A cache is a collection of data duplicating original values stored elsewhere or computed earlier, where the original data is expensive to fetch (owing to longer access time) or to compute, compared to the cost of reading the cache. Upon receipt of a read and/or write command from one or more processing units, the module controller 501 may utilize the volatile memory 503 if data related to one or more real addresses is contained within the volatile memory 503 and may only utilize the non-volatile memory 502 if data related to the one or more real addresses is not contained within the volatile memory 503. The module controller 501 may be configured to transfer data directly or indirectly between the non-volatile memory 502 and the volatile memory 503 to perform cache functions including, but not limited to, cache fills and/or page-in emulation operations. The cache may be configured to retain data contained in at least one pinned address. For example, data in the cache relating to frequently accessed real addresses may be “pinned” so that the data is retained in the cache rather than being overwritten with data relating to other real addresses during caching operations.

One or more subsets of the non-volatile memory 502 may be configured to contain a system image, or a portion of a system image, from a computer system. The system image may comprise the state of the computer system. The system image may be utilized to maintain the state of the computer system when the computer system is deprived of power (including, but not limited to, powering off of the computer system, power failures, and/or other power deprivations) and/or when the computer system enters a power saving mode (such as a hibernation feature where the state of a computer system is saved and power is not supplied to one or more components). The system image may be managed by the computer system. The system image may be managed by an operating system of the computer system.

One or more subsets of the non-volatile memory 502 may be configured to contain an emulated disk image, or a portion of an emulated disk image. An emulated disk image is a collection of data utilized to emulate the contents and structure of a data storage medium or device, such as a hard drive, CD (compact disk), or DVD (digital video disk). The emulated disk image may be utilized as if it were the emulated data storage medium or device. The emulated disk image may be managed by an operating system of a computer system.

One or more subsets of the non-volatile memory 502 may be configured as a data region for containing a page-file, or a portion of a data region for containing a page-file. The page-file may comprise a portion of memory, managed by an operating system of a computer system, where the operating system is able to load data from an auxiliary storage, such as a hard disk drive. As the page-file is typically not capable of containing the entirety of the auxiliary storage, the data may be divided in one or more pages and swapped in and/or out of the page-file by the operating system when required.

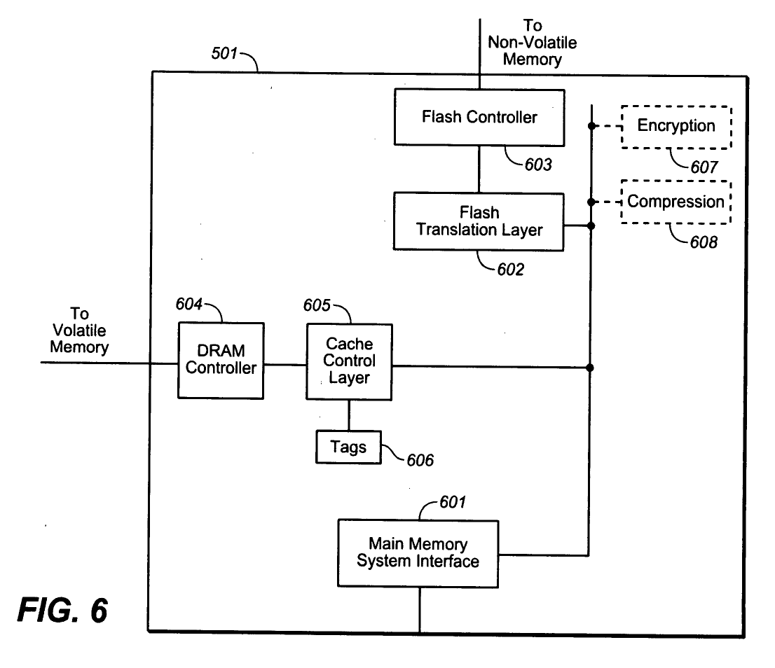

FIG. 6 illustrates an example configuration of module controller 501. The module controller 501 may include a main memory system interface 601, a flash translation layer 602 communicatively coupled to the main memory system interface 601, a cache control layer 605 communicatively coupled to the flash translation layer 602 and the main memory system interface 601, a cache tag memory 606 communicatively coupled to the cache control layer 605, a non-volatile memory controller 603 (which may comprise a flash controller) communicatively coupled to the flash translation layer 602 and the non-volatile memory 502, a volatile memory controller 604 (which may comprise a DRAM controller) communicatively coupled to the cache control layer 605 and the volatile memory 503. The main memory system interface 601 may receive one or more read and/or write commands with data from one or more processors and may determine whether to pass the one or more read and/or write commands to the flash translation layer 602 and/or the cache control layer 605 for internal processing. The main memory system interface 601 may be configured to transfer data directly or indirectly between the non-volatile memory 502 and the volatile memory 503 utilizing the flash translation layer 602, the non-volatile memory controller 603, the cache control layer 605, the cache tag memory 606, and the volatile memory controller 604.

If the module controller 501 utilizes the volatile memory 503 as a cache for the non-volatile memory 502, the main memory system interface 601 may pass the one or more read and/or write commands to the cache controller layer 605 for lookup in the cache tag memory 606. If a read command address is determined to be within a region that is within the volatile memory, the read command may be passed to the volatile memory controller 604 for processing. If the cache control layer 605 determines that a read command address will not be processed by the volatile memory 503 (including, but not limited to, a cache miss) the read command may be passed to the flash translation layer 602. If a write command address is determined to be within a region that is within the volatile memory, the write command and write data may be passed to the volatile memory controller 604 for processing. If the cache control layer 605 determines that a write command address will not be processed by the volatile memory 503 (including, but not limited to, a cache miss) the write command and write data may be passed to the flash translation layer 602.

The flash translation layer 602 may comprise a function that maps real addresses into flash blocks. This remapping and translation function may also manage wear-leveling, block erasure, and other management functions specific to flash memory devices. However, all non-volatile memory utilizes the same set of management and translation functions. If non-volatile memory 502 comprises a type of non-volatile memory other than flash memory, flash translation layer 602 may comprise a different kind of translation layer particular to the kind of non-volatile memory utilized without departing from the scope of the present disclosure. The non-volatile memory controller 603 and/or the volatile memory controller 604 may be responsible for interfacing directly to their respective memory devices and may perform functions including, but not limited to, decoding addresses to the appropriate memory devices, selecting a correct memory device, and/pr issuing the proper protocol to a memory device to read and/or write data.

The main memory controller 501 may also include an encryption unit 607 communicatively coupled to the main memory system interface 601, the flash translation layer 602, and the cache control layer 605. The encryption unit 607 may be configured to encrypt data written to the non-volatile memory 502 and/or decrypt data read from the non-volatile memory 502. The encryption unit 607 may ensure that any persistent data contained in the non-volatile memory 602 is encrypted. The encryption unit 607 may utilize any encryption algorithm including, but not limited to, the Blowfish encryption algorithm, the RSA encryption algorithm, the data encryption standard (DES), the international data encryption algorithm (IDEA), the software-optimized encryption algorithm (SEAL), and/or the RC4 encryption algorithm.

The main memory controller 501 may also include a compression unit 608 communicatively coupled to the main memory system interface 601, the flash translation layer 602, and the cache control layer 605. The compression unit 608 may be configured to compress data written to the non-volatile memory 502 and/or decompress data read from the non-volatile memory 502. The compression unit 608 may be configured to compress data written to the non-volatile memory 502 to reduce the amount of physical memory required to hold a line, page or other useful granule of memory. The compression unit 608 may utilize any compression encoding scheme including, but not limited to, the run-length encoding scheme, the Huffman encoding scheme, the arithmetic encoding scheme, the LZW encoding scheme, and the LZ-77 encoding scheme.

The main memory controller 501 may also include an encryption unit 607 communicatively coupled to the main memory system interface 601, the flash translation layer 602, and the cache control layer 605 and a compression unit 608 communicatively coupled to the main memory system interface 601, the flash translation layer 602, the encryption unit 607, and the cache control layer 605. The encryption unit 607 and the compression unit 608 may be configured to encrypt and compress data written to the non-volatile memory 502, compress and encrypt data written to the non-volatile memory 502, decompress and decrypt data read from the non-volatile memory 502, and/or decrypt and decompress data read from the non-volatile memory 502.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A computer system, comprising:
at least one processor; and
a main memory, communicatively coupled to the at least one processor, comprising:
a non-volatile memory; and
a volatile memory,
wherein the main memory includes a contiguous range of real addresses supported by the non-volatile memory and the volatile memory, the non-volatile memory is capable of containing data for every address in the contiguous range of real addresses, and the volatile memory is capable of containing data for at least a subset of the contiguous range of real addresses.

2. The computer system of claim 1, wherein the main memory includes at least one additional contiguous range of real addresses supported by the non-volatile memory and the volatile memory.

3. The computer system of claim 1, wherein the volatile memory is configured as a cache for the non-volatile memory.

4. The computer system of claim 3, wherein the cache is configured to retain data contained in at least one pinned address.

5. The computer system of claim 1, wherein the main memory further comprises a compression unit communicatively coupled to the non-volatile memory, the compression unit configured to compress data written to the non-volatile memory and decompress data read from the non-volatile memory.

6. The computer system of claim 1, wherein the main memory further comprises an encryption unit communicatively coupled to the non-volatile memory, the encryption unit configured to encrypt data written to the non-volatile memory and decrypt data read from the non-volatile memory.

7. The computer system of claim 1, wherein at least a subset of the non-volatile memory is configured to contain a system image.

8. The computer system of claim 1, wherein at least a subset of the non-volatile memory is configured to contain an emulated disk image managed by an operating system.

9. The computer system of claim 1, wherein at least a subset of the non-volatile memory is configured as a data region for containing a page-file managed by an operating system.

10. The computer system of claim 1, wherein the main memory further comprises:
at least one pluggable memory module, comprising:
a printed circuit board;
a pluggable connector, coupled to the printed circuit board;
at least a portion of the volatile memory, coupled to the printed circuit board;
at least a portion of the nonvolatile memory, coupled to the printed circuit board;
a module controller coupled to the printed circuit board and communicatively coupled to the pluggable connector, the at least a portion of the volatile memory, and the at least a portion of the nonvolatile memory.

11. The computer system of claim 1, wherein the main memory further comprises:
a main memory controller;
at least one volatile pluggable memory module, communicatively coupled to the main memory controller, comprising:
a printed circuit board;
a pluggable connector, coupled to the printed circuit board; and
at least a portion of the volatile memory, communicatively coupled to the pluggable connector; and
at least one non-volatile pluggable memory module, communicatively coupled to the main memory controller, comprising:
a printed circuit board;
a pluggable connector, coupled to the printed circuit board; and
at least a portion of the non-volatile memory, communicatively coupled to the pluggable connector.

12. A main memory for a computer system, comprising:
a memory controller, including an interface configured to communicate with a processor of the computer system;
volatile memory, communicatively coupled to the main memory controller, including at least one volatile pluggable memory module, comprising:
a printed circuit board;
a pluggable connector, coupled to the printed circuit board; and
at least a portion of the volatile memory, communicatively coupled to the pluggable connector; and
non-volatile memory, communicatively coupled to the main memory controller, including at least one non-volatile pluggable memory module comprising:
a printed circuit board;
a pluggable connector, coupled to the printed circuit board; and
at least a portion of the non-volatile memory, communicatively coupled to the pluggable connector,
wherein the main memory includes a contiguous range of real addresses supported by the non-volatile memory and the volatile memory, the non-volatile memory is capable of containing data for every address in the contiguous range of real addresses, and the volatile memory is capable of containing data for at least a subset of the contiguous range of real addresses.

13. The main memory for a computer system of claim 12, wherein the memory controller is configured to utilize the volatile memory as a cache for the non-volatile memory.

14. The main memory for a computer system of claim 13, wherein the cache is configured to retain data contained in at least one pinned address.

15. The main memory for a computer system of claim 12, wherein the memory controller further comprises a compression unit communicatively coupled to the non-volatile memory, the compression unit configured to compress data written to the non-volatile memory and decompress data read from the non-volatile memory.

16. The main memory for a computer system of claim 12, wherein the memory controller further comprises an encryption unit communicatively coupled to the non-volatile memory, the encryption unit configured to encrypt data written to the non-volatile memory and decrypt data read from the non-volatile memory.

17. The main memory for a computer system of claim 12, wherein the non-volatile memory comprises NAND flash memory.

18. The main memory for a computer system of claim 12, wherein the volatile memory comprises dynamic random access memory (DRAM).

19. A main memory module for a computer system, comprising:
a printed circuit board;
a pluggable connector, coupled to the printed circuit board;
a volatile memory, coupled to the printed circuit board;
a nonvolatile memory, coupled to the printed circuit board;
a module controller coupled to the printed circuit board and communicatively coupled to the pluggable connector, the volatile memory, and the nonvolatile memory;
wherein the volatile memory and the non-volatile memory support at least one contiguous range of real addresses for a main memory of the computer system.

20. The main memory module of claim 19, wherein the module controller is configured to utilize the volatile memory as a cache for the non-volatile memory.

21. The main memory module of claim 20, wherein the cache is configured to retain data contained in at least one pinned address.

22. The main memory module of claim 19, wherein the module controller further comprises a compression unit communicatively coupled to the non-volatile memory, the compression unit configured to compress data written to the non-volatile memory and decompress data read from the non-volatile memory.

23. The main memory module of claim 19, wherein the module controller further comprises an encryption unit communicatively coupled to the non-volatile memory, the encryption unit configured to encrypt data written to the non-volatile memory and decrypt data read from the non-volatile memory.

24. The main memory module of claim 19, wherein the non-volatile memory comprises NAND flash memory.

25. The main memory module of claim 19, wherein the volatile memory comprises dynamic random access memory (DRAM).
